(19) United States
(12) Patent Application Publication
(10) Pub. No.: US 2011/0099055 A1
(43) Pub. Date: Apr. 28, 2011

(54) METHOD OF PROCURING AND VENDING FUEL AT A DISCOUNTED PRICE

(76) Inventor: Rehan Syed Khalil, Kula, HI (US)

(21) Appl. No.: 12/607,541

(22) Filed: Oct. 28, 2009

(51) Int. Cl. G06Q 30/00; G06K 7/00

(52) U.S. Cl. 705/14.1; 235/380

(57) ABSTRACT

A method of vending fuel at a discounted price by use of a prepaid fuel card, comprising the step of allocating of a portion of the discount value negotiated by the prepaid fuel card administrator to the fuel consumer for payment of the fuel purchased. A machine and a code component for a machine comprising elements configured to set a limit on the amount of gas that can be dispensed at a gas fuel station and calculate the portion of a discount value negotiated by the prepaid fuel card administrator allocated to a sales representative and or a high volume retail vendor.

### BACKGROUND OF THE INVENTION

1. Field of the Invention

The invention relates to a method of providing discounts on the purchase of fuel. In particular the invention relates to a method of providing discounts to customers based on the use of a prepaid fuel card.

2. Description of Related Art

Producers of automobile fuel find it advantageous to offer favorable pricing to customers who purchase large volumes of fuel for their fleet of vehicles. Local retail fuel vendor's profits are not affected by these discounts, as they are negotiated with the fuel producer by the fleet customer. The retail fuel vendor and the fuel producer both benefit by the increased flow of customers through the retail fuel vendor location.

CA 1,234,632 to Fotte, et al. discloses an automated fuel discounting system that provides discounts to a club member at a number of gas stations. The system includes at least one Point of Sale (POS) console and an attendant controlled console. A remote HOST computer communicates with the attendant controlled console to determine if the member card is an appropriate valid card. It also determines if club conditions have been complied with and authorizes credit and grants a discount if the conditions are met. The attendant controlled console communicates with the gas pump processor to supply the gas pump processor with discount data so that the discount is displayed on the display of the gas pump.

CA 2,304,003 to Barrett discloses a system and/or method for subsidizing retail gasoline purchases (i.e. either subsidizing the purchase cost to the consumer and/or price to the gasoline retailer) at a number of gasoline retail locations on a preferred transportation route(s) and/or during preferred commuter times, etc. The system has the intent of altering retail gasoline consumers' behavior (including altering traffic patterns within a specific geographic locality and/or causing consumers to visit a predetermined geographic area) through a system of economic incentives.

U.S. Pat. No. 2,346,410 to Klingle discloses a process, system and computer readable medium for using a customer's identification, such as a frequent shopper card, as a prepaid fuel card in conjunction with a transfer certificate containing a transfer certificate identification.

U.S. Pat. No. 6,732,081 to Nicholson discloses a method of providing multiple level discounts on a first product to a customer who purchases at least one cross-marketed product. The method comprises the steps of awarding a first discount on the first product to the customer based on a purchase by the customer of a first cross-marketed product, awarding a second discount on the first product to the customer based on a purchase by the customer of a second cross-marketed product, adding the first discount to the second discount to determine a total discount on the first product, and awarding the total discount to the customer.

US 2005/0149402 to Nicholson discloses a method of providing multiple level, price-per-unit (PPU) discounts on gasoline to a customer who purchases at least one cross-marketed product. The customer is awarded a first PPU discount on the gasoline based on a purchase by the customer of a first cross-marketed product, and is awarded a second PPU discount based on the purchase of a second cross-marketed product. The first discount is then added to the second discount to determine a total PPU discount, and a paper receipt is printed for the customer with customer identification and transaction identification encoded in a bar code thereon. The total discount is stored in a discounts issued database. The customer then scans the encoded bar code with a bar code scanner at a gasoline dispenser to redeem the discount. The total discount is retrieved from the discounts issued database, and the gasoline station then reduces the price-per-unit-volume of the gasoline by an amount equal to the total discount. When the customer completes the gasoline purchase, a value of the total discount redeemed is determined and stored in a discounts redeemed database. Portions of the discount redeemed are then allocated to vendors of the first and second cross-marketed products according to predetermined criteria.

US 2006/0095328 to Kane, et al. discloses a system and method of providing discounts to customers on the purchase of gasoline, and in particular to a system and method in which customers earn discounts when performing certain actions, such as making purchases, wherein the discounts are associated with customer identification information and may be redeemed by the customers when purchasing gasoline using the customer identification information.

In general, a variety of discount credit cards, gift cards, loyalty discount cards and rebate deal cards are known in the marketplace. However credit cards typically require credit checks, fees and other requirements. The typical gift card does not offer discounts at the pump. Currently, prepaid cards that may be used to purchase fuel at a discount are unknown.

Currently, large corporate and government consumers negotiate prices with oil companies on the basis of the volume of products they will consume a given time frame. The individual consumer or small business lacks this purchasing power. Therefore, there is a need in the marketplace to provide such individuals or small businesses with the purchasing power to negotiate prices with oil companies.

### SUMMARY OF THE INVENTION

One embodiment of the invention is a method of procuring and vending fuel at a discounted price than that posted at a gas fuel station by use of a prepaid fuel card. The method comprises the steps of a prepaid fuel card administrator negotiating a discount value from a fuel supplier, selling prepaid fuel cards to users, use of the prepaid fuel card by the user to, purchase fuel, and allocation of a portion of the discount value negotiated by the prepaid fuel card administrator to the fuel consumer for payment of the fuel purchased.

Another embodiment of the invention is a machine for vending fuel at a discounted price than that posted at a gas fuel station by use of a prepaid fuel card comprising elements configured to:

a) retrieve account information associated with a prepaid fuel card;

b) set a limit on the amount of gas that can be dispensed at a gas fuel station;

c) calculate the remaining value of the prepaid fuel card after dispensing gas; and

d) calculate the portion of a discount value negotiated by the prepaid fuel card administrator to a sales representative and or a high volume retail vendor.

Another embodiment of the invention is a code component for a machine configured to vend fuel at a discounted price than that posted at a gas fuel station by use of a prepaid fuel card comprising code for the steps of:

a) retrieving account information associated with an encoded prepaid fuel card;

b) setting a limit on the amount of gas that can be dispensed at a gas fuel station;

c) calculating the remaining value of the prepaid fuel card after dispensing gas; and

d) calculating the portion of a discount value negotiated by the prepaid fuel card administrator to a sales representative and or a high volume retail vendor.

### BRIEF DESCRIPTION OF THE DRAWINGS

FIG. 1 is a flow chart illustrating the overall method of negotiating a discount value, distributing prepaid fuel cards, using the prepaid fuel cards to purchase fuel and allocating a portion of the negotiated discount for the payment of fuel.

FIG. 2 is a schematic for a representative machine component configured to carry out the steps of the invention.

### DESCRIPTION OF PREFERRED EMBODIMENTS

The invention is a method of procuring and vending fuel at a discounted price than that posted at a gas fuel station by use of a prepaid fuel card.

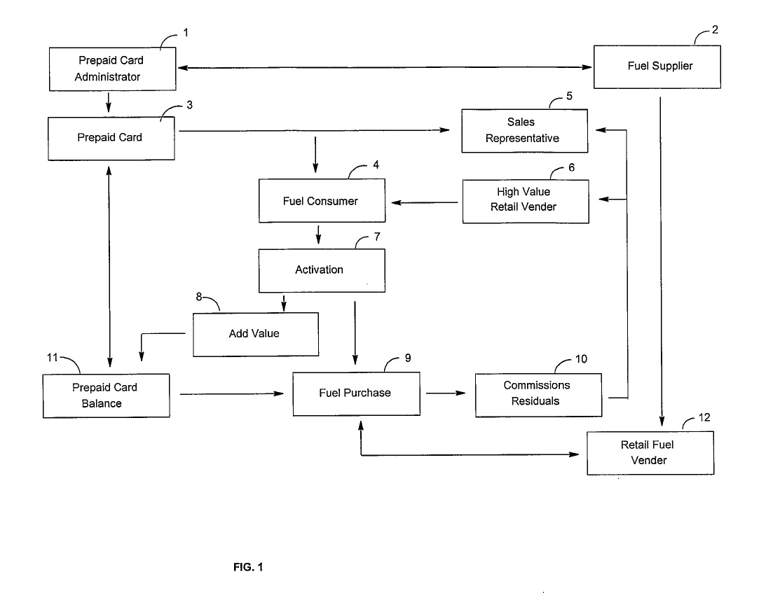

With reference to FIG. 1, a prepaid card administrator (1) negotiates discount with fuel supplier (2). The fuel supplier (2) provides fuel to the retail fuel vendor (12). The prepaid card administrator (1) sells prepaid fuel cards (3) to the fuel consumer (4) and/or provides prepaid fuel cards (3) to a sales representative (5) that provides the cards to a high volume retail vender (6) that sells to consumer (4). The prepaid card administrator (1) maintains a data base (11) containing account information, such as verification PIN, balance, as well as any routing information for a sales representative (5) or high volume retail vendor (6) information associated with each card.

As a non-limiting example, a prepaid fuel card, having a face value, may be purchased from a high volume retail vendor where products or services are purchased such as department stores, grocery stores, mini-marts, or warehouse stores, etc. The prepaid fuel card may also be purchased or refilled at the prepaid card administrators internet website or by calling the prepaid card administrators toll free number. The cards may be sold to the high volume retail vendor at a discount to the face value of the card by wholesale sales representative. The high volume retail vendor swipes the prepaid fuel card through a magnetic stripe reader, and contacts fuel card administrator through a telephonic connection. While in contact with the fuel card administrator the fuel consumer may activate, establish a verification PIN number for or add value to the prepaid fuel card. The high volume retail vendor collects funds, and uses electronic funds transfer to provide appropriate funds to the fuel card administrator. Typically, the value added to a face value prepaid fuel card can not exceed the face value. A face value card may also be upgraded to a fuel card administrator membership prepaid fuel card. Typically, a fuel card administrator membership card provides a larger discount then the face value card.

As a non-limiting example, a prepaid fuel card may also be purchased directly from a prepaid card administrator. Typically, a fuel card administrator will have a member services office or a website for purchasing a membership, establishing account information, deposit an amount to the account for the purchase of fuel, creating a verification PIN number, confirming a shipping address and conversion of a face value card to a fuel card administrator membership card. After the card is obtained the card is activated using the PIN number. A prepaid fuel card, typically awards larger discounts then the face value card.

Additionally, the purchase of prepaid fuel cards may be made together with automobile payments as one lump sum, by arrangement between the prepaid fuel card administrator and automobile dealers and or auto manufacturers.

With reference again to FIG. 1, the fuel consumer (4) uses the card by providing a PIN number to (7). After providing a PIN number the fuel consumer (4) may add value (8) toe card or purchase fuel (9). Adding value (8) to the card credits the balance information in the database (11). A fuel purchase (9) debits the balance information in the database (11). A fuel purchase (9) credits the retail fuel vendor (12). A portion of the discount negotiated by the prepaid fuel card administrator (1) is applied to the fuel purchase (9). A portion of the discount negotiated by the prepaid fuel card administrator (1) may be in the form of a discount to a face value of the prepaid fuel cards. The retail fuel vendor (12) provides fuel to the fuel consumer (4). Any commissions and/or residuals (10) from the fuel purchase (9) may be paid to a sales representative (5) or high volume retail vender (6).

As a non-limiting example, the customer must purchase fuel from a participating fuel producer at a participating retail fuel vendor. When customer swipes the prepaid fuel card at a participating retail fuel vendor, a signal is sent to fuel card administrator. The fuel card administrator scans the account, validates availability, and sends message ‘enter PIN’. The customer enters the PIN. If the PIN is incorrect, the fuel card administrator sends message ‘invalid PIN’ and ends the transaction, and the customer must start the process again to retry. If the PIN is correct, fuel card administrator sends message, ‘Please lift handle and start pump’. In the background, fuel card administrator sets a limit on the value of fuel which may be charged to the account and limits the gallons which can be delivered. Preferably, the limit on the units of gas that can be dispensed at a gas fuel station is the face value of the prepaid-fuel card divided by the price per unit of gas. When fueling is finished, fuel card administrator sends message ‘do you want a receipt? yes no’. If no, the transaction ends. If yes, the receipt is printed displaying the gallons delivered, amount charged to the account, and the account balance. Deposits are added to the customer account. Fuel purchases are deducted from the customer account, the remaining value of the prepaid fuel card is the face value of the prepaid-fuel card less the value of the gas dispensed. Funds are remitted to fuel supplier at end of purchase transaction along with a report of gallons, pump price, and retail fuel vendor identification. Electronic funds transfer is employed to deliver any appropriate funds to the high volume retail vendor and/or wholesale sales representative as well as the fuel card administrator. The portion of a discount value negotiated by the prepaid fuel card administrator to a sales representative and or a high volume retail vendor may be the ratio of the value used to purchase gas to the total face value prepaid-fuel card times a negotiated percentage.

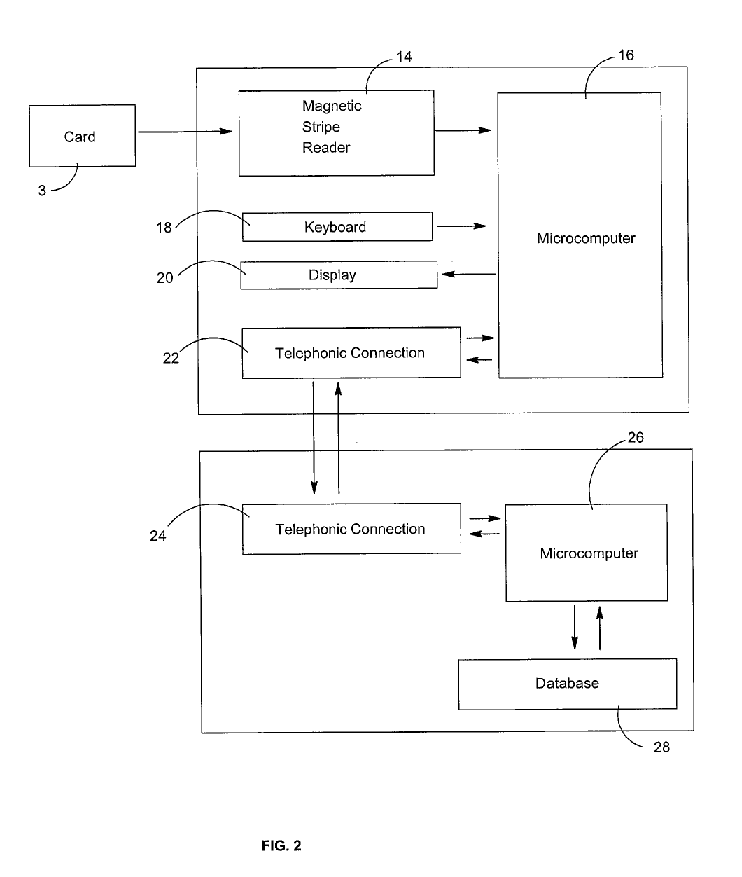

With reference to FIG. 2 the machine component of the invention uses a prepaid fuel card (3) which is read by a magnetic stripe reader (14) that is operatively connected to a point of sale microcomputer (16). The fuel card user enters a PIN number and selects the amount of fuel to be dispensed with a keyboard (18) operatively connected to a point of sale microcomputer (16). The point of sale microcomputer (16) which is operatively connected to a display (20), displays a prompt for the fuel card user to enter a PIN number and amount of fuel to be dispensed. The point of sale microcomputer (16), which is also operatively connected to a telephonic connection (22), sends the information entered by the fuel card user to the fuel card administrator microcomputer (26), which is operatively connected to a telephonic connection (24). The fuel card administrator microcomputer (26), which is also operatively connected to a database (28), retrieves fuel card user information from the database and performs the code component operations of the invention on the information as required.

Code component operations include setting a limit on the amount of gas that can be dispensed at a fuel station, calculating the portion of the discount value negotiated by the fuel card administrator to a sales representative or a high volume retail vendor, verify a PIN number associated with a distinctive account number prior to the delivery of fuel and calculating the remaining value of the prepaid fuel card after dispensing gas.

In one embodiment the machine and code component of the invention are additionally configured to calculate the amount of money saved by a prepaid card user for an amount of fuel entered into a website widget.

The machine and code components of the invention are of the type which are known to those skilled in the art, and are currently used at most retail locations for credit cards.

1. A method of vending fuel at a discounted price than that posted at a gas fuel station by use of a prepaid fuel card, comprising the steps of:
a) a prepaid fuel card administrator negotiating a discount value from a fuel supplier;
b) selling prepaid fuel cards to users; and
c) allocation of a portion of the discount value negotiated by the prepaid fuel card administrator to the fuel consumer for payment of the fuel purchased.

2. A method of claim 1 that further comprises the step of encoding a prepaid fuel card with a distinctive account number.

3. A method of claim 2 that further comprises the step of encoding a prepaid fuel card with routing information for a telephonic connection between a retail fuel vendor and the fuel card administrator.

4. A method of claim 3 that further comprises the step of encoding a prepaid fuel card with routing information for the electronic transfer of funds to a sales representative or a high volume retail vendor.

5. A method of claim 4 that further comprises the steps of reading an encoded prepaid fuel card and establishing a telephonic connection between a retail fuel vendor and the fuel card administrator.

6. A method of claim 5 that further comprises the steps of providing a PIN number associated with the distinctive account number and verifying the PIN number prior to the delivery of fuel.

7. A method of claim 6 further comprising the step of limiting the amount of purchased fuel based on account information.

8. A method of claim 4 further comprising the allocation of a portion of the discount value negotiated by the prepaid fuel card administrator to the sales representative and or the high volume retail vendor.

9. A method of claim 8 in which the allocation of a portion of the discount value negotiated by the prepaid fuel card administrator to the fuel consumer is in the form of a discount to a face value of the prepaid fuel cards.

10. A machine for vending fuel at a discounted price than that posted at a gas fuel station by use of a prepaid fuel card comprising elements configured to:
a) retrieve account information associated with a prepaid fuel card;
b) set a limit on the amount of gas that can be dispensed at a gas fuel station;
c) calculate the remaining value of the prepaid fuel card after dispensing gas; and
d) calculate the portion of a discount value negotiated by the prepaid fuel card administrator allocated to a sales representative and or a high volume retail vendor.

11. A machine according to claim 10 in which the prepaid fuel card is encoded with a distinctive account number, routing information for a telephonic connection between a retail fuel vendor and the fuel card administrator, routing information for the electronic transfer of funds to a sales representative or a high volume retail vendor and optionally a PIN number.

12. A machine according to claim 11 configured to read the encoded prepaid fuel card and establish a telephonic connection between a retail fuel vendor and the fuel card administrator

13. A machine according to claim 12 comprising a magnetic stripe reader and a telephonic connection between a retail fuel vendor and the fuel card administrator.

14. A machine according to claim 11 additionally configured to verify a PIN number associated with the distinctive account number prior to the delivery of fuel.

15. A machine according to claim 11 additionally configured to transfer a portion of the discount value negotiated by the prepaid fuel card administrator to the sales representative and or the high volume retail vendor.

16. A machine according to claim 11 additionally configured to calculate the amount of money saved by a prepaid card user for an amount of fuel entered into a website widget.

17. A code component for a machine configured to vend fuel at a discounted price than that posted at a gas fuel station by use of a prepaid fuel card comprising code for the steps of:
a) retrieving account information associated with an encoded prepaid fuel card;
b) setting a limit on the amount of gas that can be dispensed at a gas fuel station;
c) calculating the remaining value of the prepaid fuel card after dispensing gas; and
d) calculating the portion of a discount value negotiated by the prepaid fuel card administrator allocated to a sales representative and or a high volume retail vendor.

18. A code component according to claim 17 additionally comprising code for the steps of reading the encoded prepaid fuel card and establishing a telephonic connection between a retail fuel vendor and the fuel card administrator.

19. A code component according to claim 17 additionally comprising code for the steps of verifying a PIN number prior to the delivery of fuel

20. A code component according to claim 17 additionally comprising code for the step of transferring a portion of the discount value negotiated by the prepaid fuel card administrator to the sales representative and or the high volume retail vendor.

21. A code component according to claim 17 in which the limit on the units of gas that can be dispensed at a gas fuel station is the face value of the prepaid-fuel card divided by the price per unit.

22. A code component according to claim 17 in which the remaining value of the prepaid fuel card is the face value of the prepaid-fuel card less the value of the gas dispensed.

23. A code component according to claim 17 in which the portion of a discount value negotiated by the prepaid fuel card administrator to a sales representative and or a high volume retail vendor is the ratio of the value used to purchase gas to the total face value prepaid-fuel card times a negotiated percentage.

24. A code component according to claim 17 additionally comprising code for the step of calculating the amount of money saved by a prepaid card user for an amount of fuel entered into a website widget.
